(19) United States
(12) Patent Application Publication
(10) Pub. No.: US 2017/0060160 A1
(43) Pub. Date: Mar. 2, 2017

(54) LOAD SHED CALIBRATION

(71) Applicant: Leviton Manufacturing Co., Inc., Melville, NY (US)

(72) Inventor: Richard A. Leinen, Wilsonville, OR (US)

(21) Appl. No.: 15/238,157

(22) Filed: Aug. 16, 2016

Related U.S. Application Data
(60) Provisional application No. 62/212,904, filed on Sep. 1, 2015.

(51) Int. Cl. G05F 1/66; G05B 19/042

(52) U.S. Cl. CPC G05F 1/66; G05B 19/0428; G05B 2219/39361

(57) ABSTRACT

A load control system may include a load control device and a load, in which the load control device is adapted and configured to control power supplied to the load. The load may include metrology adapted and configured to determine an amount of power output of the load at each of a plurality of load control levels of the load control device to translate linear load control level to linear power output. In a demand response system, when the load control system is directed to reduce its power consumption by a given amount, the load control device may be changed to an appropriate load control level so that the power consumption of the associated load is reduced by the given amount in the demand response request.

### FIELD OF THE DISCLOSURE

The present disclosure relates generally to a load control system, and more particularly, relates to a load control system including enhanced load shed calibration.

### DESCRIPTION OF THE RELATED ART

The amount of electric power required to power a city or country is growing. To meet the demands, power producing plants need to increase production, and where possible, provide incentives to reduce usage. In addition, the amount of electric power demanded from a power plant or utility grid varies depending on the time of day, time of year, local weather patterns, failure of other power plants on the utility grid, and other factors that may be difficult to predict. Overloading the power plant or utility grid during periods of peak demand may cause failure of the power plant or utility grid, under voltage events (i.e. brownouts), or may force a utility company to activate reserve generating capacity, which is typically expensive to operate.

To balance the supply and demand of power usage, utility companies will typically offer financial incentives (i.e. credits, reduced billing rates, rebates, etc.) to customers who agree to participate in a demand response system. A demand response system directs a customer to reduce its power demand during periods of peak demand, thereby enabling the utility company to improve the reliability of its power plant and/or utility grid and reduce its operating costs. In a demand response system, the utility company contacts the customer when needed (for example, if it becomes apparent that the peak load will exceed the capacity of the power plant or utility grid, or when power will be relatively expensive to generate). One way that the customer may respond to the demand response request from the utility company is by reducing its power consumption, which is generally referred to as load shedding. For example, the utility company may request that the customer reduce its power consumption by a given percentage in the summer afternoons when demand for power is at its peak.

In the instance of lighting, when a utility company directs a customer to reduce its power consumption by a given load shed percentage, the lighting control level of the lighting control device is typically reduced by the given load shed percentage, thereby reducing the light output or light intensity of the associated lighting load by the given load shed percentage. This occurs because the lighting control level is typically applied to a dimmer curve that is calibrated so that a linear lighting control level input produces a relatively linear light output. However, linear light output or light intensity does not always translate to linear power output; so, when a customer responds to a demand response request by reducing the lighting control level input by the given load shed percentage, the result may be a corresponding reduction in light output or light intensity, but not necessarily a corresponding reduction in power output. Thus, the intent of the demand response request is not always accomplished. For example, if the utility company directs the customer to reduce its power consumption by ten percent, the customer will typically dim its lighting loads by ten percent. But, this ten percent reduction in light output or light intensity may only result in a seven percent reduction in power output or consumption; and thus, the customer does not meet the requirements communicated in the demand response request calling for a ten percent reduction in power consumption. Thus, what is needed is a more accurate way to reduce power output or consumption by the appropriate amount.

### BRIEF DESCRIPTION OF THE SEVERAL VIEWS OF THE DRAWING(S)

One or more aspects of the disclosed subject matter are particularly pointed out and distinctly claimed as examples in the claims at the conclusion of the specification. The foregoing and other objects, features, and advantages of the disclosed subject matter may be more readily understood by one skilled in the art with reference being had to the following detailed description of several embodiments thereof, taken in conjunction with the accompanying drawings wherein like elements are designated by identical reference numerals throughout the several views, and in which:

FIG. 1 is an exemplary diagram of a customer building including a load control system;

FIG. 2 is an exemplary embodiment of a load;

FIG. 3 is a flow chart illustrating an exemplary embodiment of a method for calibrating or configuring a load control level of a load control device to power output of a load;

FIG. 4 is an exemplary look-up table layout;

FIG. 5 is a flow chart illustrating an exemplary embodiment of a method for reducing power output of a load control system; and

FIG. 6 is an exemplary embodiment of a transfer curve.

### DETAILED DESCRIPTION

The present disclosure describes a load control system and method for calibrating or configuring a load control level of a load control device to power output of an associated load. Embodiments will be described below while referencing the accompanying figures. The accompanying figures are merely examples and are not intended to limit the scope of the present disclosure.

FIG. 1 is an exemplary diagram of a customer building 10 incorporating an energy management system according to some inventive principles of the present disclosure. The building 10 may include various utility service inputs, including but not limited to, electricity 20. The electricity 20 may be generated and provided by a power plant of a utility company. The power plant is able to provide power to the building 10 via a substation, electrical power lines, and a transformer (not shown). In addition, the building 10 may include various building systems that provide loads on the utilities, including but not limited to a load control system 50.

The load control system 50 may include a load control device 60 and an associated load 70. The load control device 60 is adapted and configured to control the amount of power delivered to the load 70 and the intensity level of the load 70. The load 70 and the load control device 60 may be directly connected or connected over a wired or wireless network. The load control device 60 may include, but not limited to, a relay, a dimmer, a switch, an occupancy sensor, a photocell, etc. The load control device 60 may be adapted and configured to turn the load on and off, or to adjust the output from the load 70 over a range from 0% to 100% of full output at fixed or variable rates. In addition, the load control device 60 may adjust the output from individual loads and/or groups or circuits of loads collectively. In the exemplary embodiment shown in FIG. 1, the load 70 is a light; however, the light is merely an exemplary load, and the load may include but not limited to, a fan, HVAC, motor, other types of loads that do not provide illumination, any type of light or combination of lights that would generally be installed in a building, including but not limited to fluorescent light, incandescent light, halogen light, light-emitting diode, etc.

Although the load control system 50 shown in FIG. 1 includes only one load 70 and one load control device 60, a person of ordinary skill in the art will recognize that a typical building includes a plurality of loads and corresponding load control devices. For example, a building may incorporate several lighting systems, each providing light to different spaces in the building. In addition, a person of ordinary skill in the art will recognize that many other variations of the load control system 50 are possible and fall within the inventive principles described therein.

As further described below, the building 10 may include a demand response system or a load shed system having a control command that directs the building to reduce its power consumption by a given percentage, value or load shed number. The building 10 may also include a meter 30. Individual loads or groups of loads may also have associated submeters, such as submeter 40. Although only one submeter is shown in the exemplary embodiment of FIG. 1, a person of ordinary skill in the art will recognize that a building may have submeters on any number of loads and subsystems in the building 10. In addition, the meter or submeter may be incorporated into the one or more loads themselves.

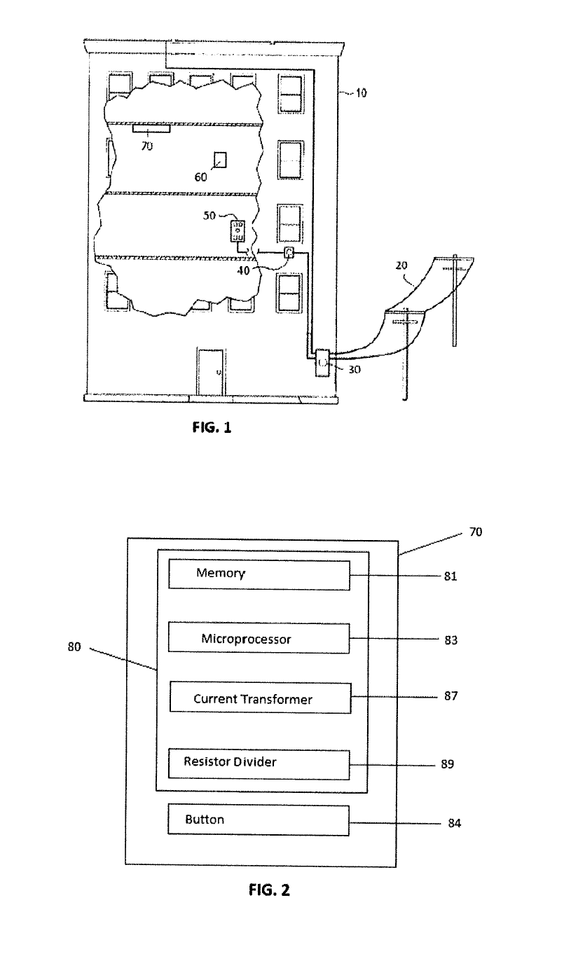

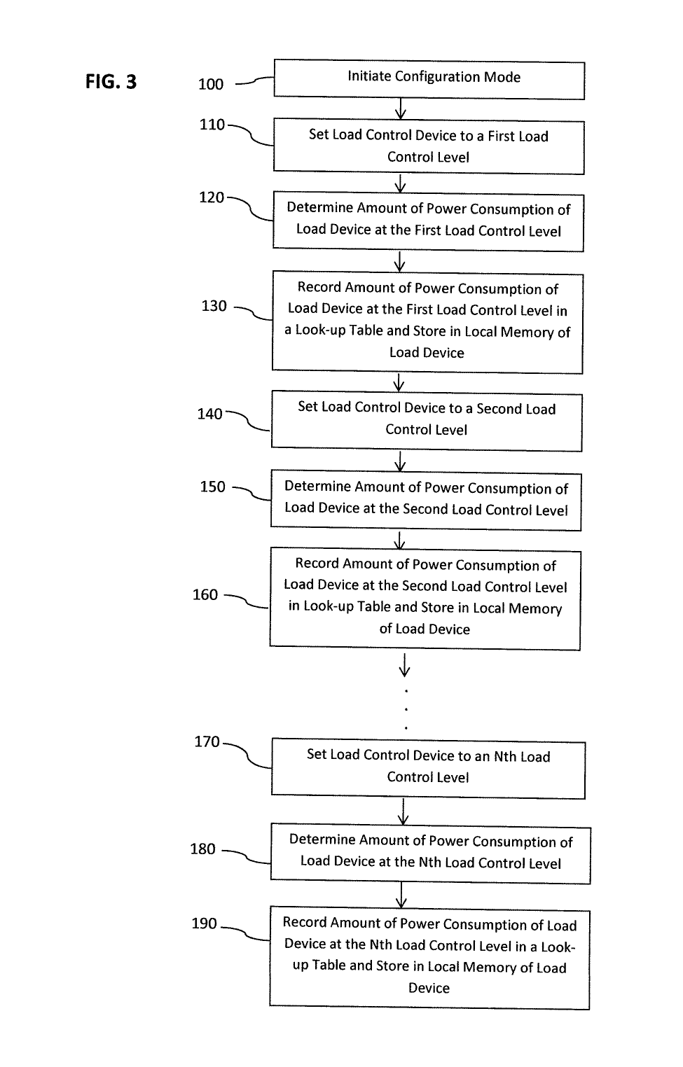

As shown in FIG. 2, the load 70 may include metrology 80 adapted and configured to measure the power output of the load 70 at various load control levels. The metrology 80 of the load 70 may include non-volatile memory 81, a microprocessor 83, a current transformer 87 (i.e. a toroid), and a resistor divider 89. The metrology 80 is adapted and configured to measure the amount of current and voltage, and calculate the power output of the load 70 at the various load control levels. The non-volatile memory 81 is adapted and configured to store the power output of the load 70 at the various load control levels. One of ordinary skill in the art will appreciate other variations and methods to determine the amount of current, voltage, and/or power output of the load. In addition, other embodiments may include metrology associated with more than one load or may be located at a different location from the load. Additionally, metrology components (e.g. non-volatile memory 81, microprocessor 83, current transformer 87, resistor divider 89) may be housed in any suitable location within the building, for example, within the load control device 60.

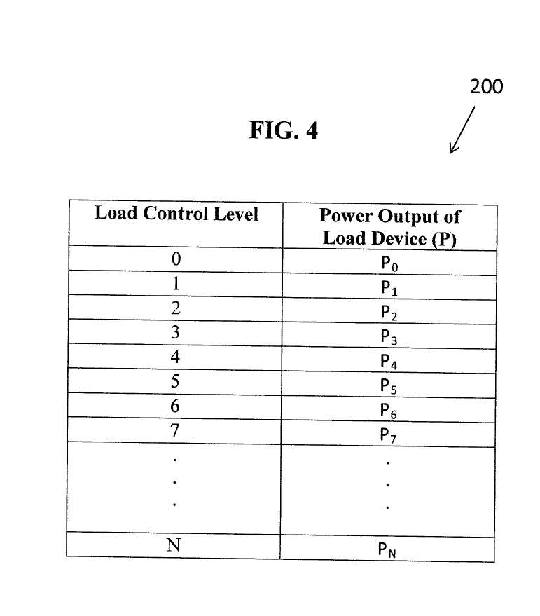

Using the metrology 80, various load control levels of the load control device 60 may be calibrated or configured to power output of the load 70. Referring to FIG. 3, at step 100, a configuration mode of a load control system may be initiated on a per load basis. The configuration mode may be initiated by actuating a button 84 (see FIG. 2) on the load 70 or a button on the load control device 60. Alternatively, the configuration mode may be initiated by sending a network control message, or any other means now known or hereafter developed by one of ordinary skill in the art. After the configuration mode is initiated, at step 110, the load control device is set to a first load control level; and at step 120, the amount of power consumption of the load at the first load control level is determined. At step 130, the amount of power consumption of the load at the first load control level is then recorded in a look-up table (see FIG. 4) and stored in non-volatile memory of the load. At step 140, the load control device is then set to a second load control level; and at step 150, the amount of power consumption of the load at the second load control level is determined. At step 160, the amount of power consumption of the load at the second load control level is then recorded in the look-up table (see FIG. 4) and stored in the non-volatile memory of the load. Calibration or configuration of the load control level of the load control device to power output of the load may continue N times, where N is any suitable number. The range of measurements would preferably extend from the minimum light output (or no light output) to the maximum light output. Increments could vary, but preferably would be 100 increments to cover 1%-100%. At step 170, the load control device is set to an Nth load control level; and at step 180, the amount of power consumption of the load at the Nth load control level is determined. At step 190, the amount of power consumption of the load at the Nth load control level is then recorded in a look-up table (see FIG. 4) and stored in the non-volatile memory of the load. Alternative embodiments may make measurements at any suitable increments and further may optional interpolate intervening values. Such interpolation may be of any suitable type such as linear, polynomial, and/or spline interpolation.

After the configuration mode is initiated at step 100, the load control system is preferably adapted and configured to automatically proceed through the steps 110-190 in a controlled manner with a linear control signal, which is assumed to be linear load output (i.e. lighting output or light intensity), and the respective power output is measured accordingly.

One of ordinary skill in the art will understand that the resolution of the calibration or configuration may differ based on the number or incremental percent of load control levels that the user chooses to calibrate or configure using the steps described above and outlined in FIG. 3. For example, in alternative embodiments, the user may choose to calibrate or configure every other value of load control level to its respective power output.

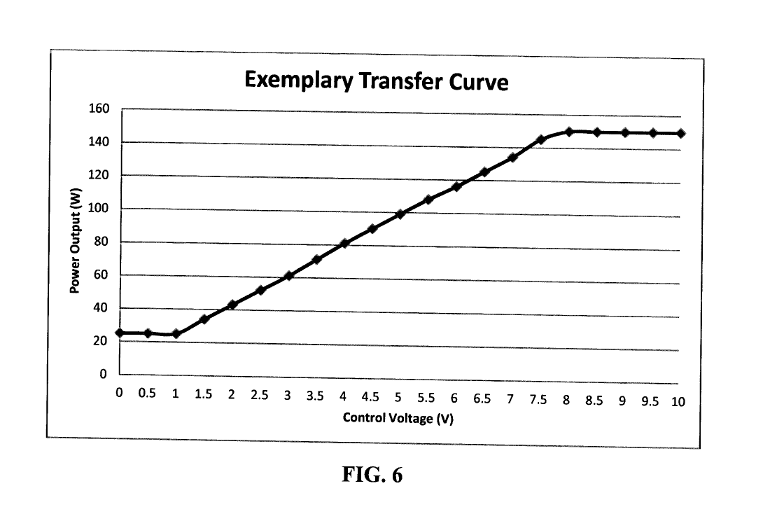

Based on the information obtained from the steps outlined in FIG. 3 and described above, a look-up table 200, as shown in FIG. 4, may be created. The look-up table 200 may include a first column including each load control level of the load control device, and a second column including the power output (i.e. amount of power consumption) of the load at each corresponding load control level. Additionally, based on the information in the look-up table 200, a transfer curve, such as the exemplary embodiment of a transfer curve shown in FIG. 6 for power may be produced, and stored in the non-volatile memory of the load. The look-up table and the transfer curve translate linear control level input to linear power output, which more accurately determines power output than relying on a dimmer curve that translates linear control level input to linear load output (i.e. light output or light intensity).

As shown in the exemplary embodiment of the transfer curve of FIG. 6, from control voltage levels from approximately 0-1 v and 8-10 v, power output is relatively stable. That is, the load control level of the load control device may change, with relatively little or no change in the power consumption of the corresponding load. However, at control voltage levels from approximately 1-7.5 v, power output is relatively linear with control voltage. One of ordinary skill in the art will understand that FIG. 6 shows only one example of a transfer curve, and other transfer curves of different shapes and values may be produced. In addition, various factors may affect the shape of the transfer curve for power. For example, the amount of power that a driver of the load requires may affect the shape of the transfer curve, as the amount of power that the driver requires is a fixed amount so at lower load control levels, the load control level may need to be reduced even further (than it otherwise would at higher load control levels) to reduce the power output of the load since a portion of the power consumption of the load (i.e. the amount of power that the driver draws) is not going to change with a reduction in the load control level.

Each load in the load control system may be calibrated or configured separately (on a per load basis) using the steps detailed in FIGS. 3-4 and described above. After calibrating or configuring the load control level to the power output of one or more loads (see FIGS. 3-4), the amount of power consumption of each load at each load control level is known. That is, the measured power output of the load for each percentage change (or a determined amount of percentage change) of the load control device is known. So, when a demand response or load shed system in the building (i.e. the building 10 in FIG. 1) receives a demand response message from the utility company requesting that the customer reduce its power consumption by a given percentage, the customer is better able to reduce the amount of power by the given percentage based on the power output of the load as opposed to reducing the load output (i.e. light output or light intensity) by the given percentage. In addition, the customer can reduce the actual power consumption by a given amount or percentage versus simply reducing the load control level by a given amount or percentage.

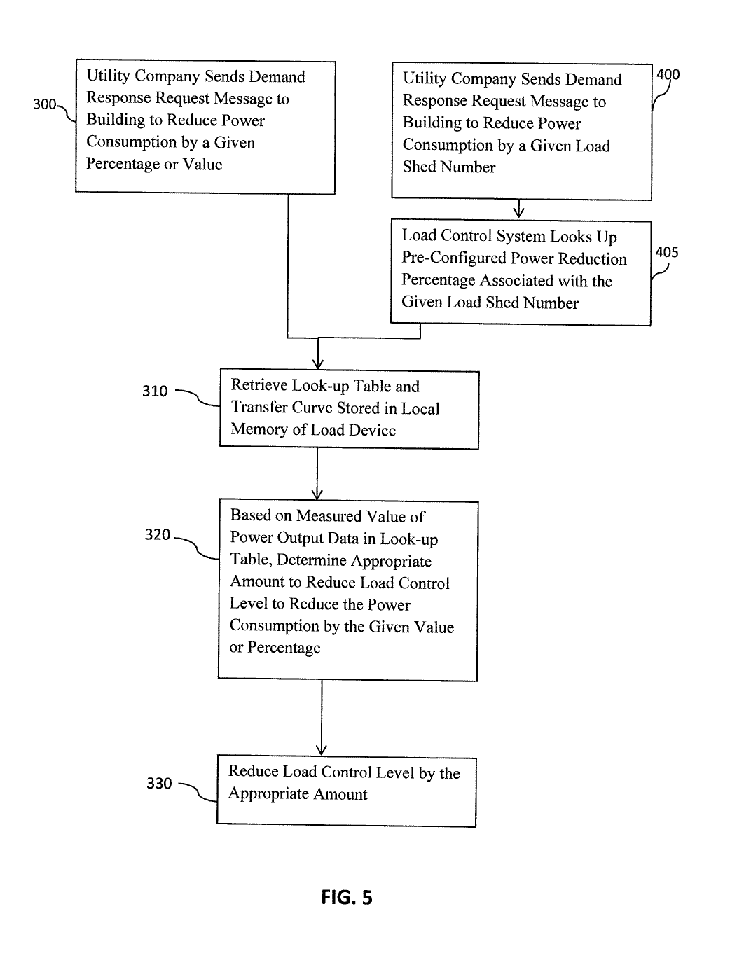

As mentioned above, an exemplary embodiment for reducing power output is illustrated in FIG. 5. Initially, at step 300, a utility company may send a demand response request message to a customer directing it to reduce its power consumption by a given percentage or value (i.e. a load shed command). Alternatively, at step 400, the utility company may send a demand response request message to a customer directing it to reduce its power consumption by a given load shed number; and, at step 405, the load control system, which is pre-programmed or pre-configured with information or a look up table that associates load shed numbers with power reduction percentages, retrieves the pre-configured power reduction percentage that is associated with the given load shed number. The demand response request message sent in step 300 or step 400 may be sent directly to the building energy management system or the load control system of the customer building. In addition, the demand response request message may be in the form of a digital message through a radio transmission, internet connection, or other medium.

At step 310, the load control system may retrieve a look-up table (i.e. see FIG. 4) and a transfer curve (i.e. see FIG. 6) stored in non-volatile memory of the load (i.e. the non-volatile memory 81 of the load 70 in FIGS. 1-2), in which the load was pre-calibrated or pre-configured using the steps outlined in FIGS. 3-4 and described above. At step 320, based on the measured value of the power output information in the look-up table and the transfer curve, the load control system may determine the appropriate amount or percentage to reduce the load control level by in order to reduce the power consumption by the given percentage, value, or load shed number directed in the demand response request message. At step 330, the load control level is reduced by the appropriate amount or percentage, resulting in the power consumption of the load being reduced by the given percentage, value, or load shed number directed in the demand response request message. Thus, the power consumption of the load is reduced by the appropriate amount, meeting the requirements of the demand response message or load shed command.

One of ordinary skill in the art will appreciate that after each load is calibrated or configured, the load control system may be adapted and configured to sum the total power consumption of the load control system, and reduce the power output of each load accordingly. In addition, knowing the total power consumption of the load control system allows the customer to select which loads to reduce. For example, if the power output of one load cannot be reduced, the customer may reduce the percentage of the power output of another load more than the given load shed percentage in the demand request message in order to compensate for the load that is not reduced.

The exemplary embodiments described above disclose a load control system, which may include a lighting control system. However, it will be understood by one of ordinary skill in the art that other types of load control systems may be used.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. A method comprising the steps of:
a. receiving a demand response request message from a utility company requesting a reduction in the amount of power consumed, the demand response request message requesting a customer to reduce the amount of power consumed by a given amount;
b. using pre-configured information stored in a load control system, determining an appropriate load control level of a load control device to reduce an associated load in order to reduce the amount of power consumed by the given amount, wherein the load control device is adapted and configured to control power supplied to the associated load, and wherein the pre-configured information includes power output information of the associated load at a plurality of corresponding load control levels; and
c. changing the load control device to the load control level to reduce the power consumption of the associated load by the given amount.

2. The method of claim 1, wherein the pre-configured information is stored in non-volatile memory assigned to the associated load.

3. The method of claim 1, wherein the pre-configured information is in the form of at least one of a look-up table and a transfer curve.

4. The method of claim 1, wherein the pre-configured information correlates load control level to load power output.

5. The method of claim 1, wherein the pre-configured information includes the power output of the associated load for a plurality of percentage changes of the load control level.

6. The method of claim 1, wherein the associated load includes associated metrology to determine the power output of the load at a plurality of corresponding load control levels.

7. The method of claim 1, wherein the load control device is a lighting control device, and the load is a light.

8. The method of claim 1, wherein the given amount is a given percentage.

9. The method of claim 1, wherein the given amount is a given load shed number.

10. The method of claim 9 further comprising looking up a pre-configured power reduction percentage associated with the given load shed number.

11. A method for calibrating a control level of a load control device to a power output of a load, the method comprising the steps of:
a. initiating a configuration mode;
b. setting the load control device to a first load control level, wherein the load control device is adapted and configured to control an amount of power supplied to the load;
c. determining an amount of power output of the load at the first load control level of the load control device;
d. recording the amount of power output of the load at the first load control level of the load control device;
e. setting the load control device to a second load control level;
f. determining the amount of power output of the load at the second load control level of the load control device; and
g. recording the amount of power output of the load at the second load control level of the load control device.

12. The method of claim 11, wherein the load control device is adapted and configured to automatically perform steps (b) thru (g) upon initiating the configuration mode in step (a).

13. The method of claim 11, wherein the amount of power output of the load at the first load control level of the load control device and at the second load control level of the load control device is recorded in a look-up table and stored in non-volatile memory.

14. The method of claim 13, further comprising the steps of producing a transfer curve from information in the look-up table, and storing the transfer curve in the non-volatile memory.

15. The method of claim 11, wherein the amount of power output of the load at the first load control level of the load control device and at the second load control level of the load control device translates linear control level input to linear power output.

16. The method of claim 11, wherein the power output of the load for each percentage change of the load control level is determined.

17. The method of claim 11, wherein the load is a lighting device.

18. A load control system comprising:
a. a load;
b. a load control device adapted and configured to control an amount of power supplied to the load, the load control device having a plurality of load control levels;
wherein the load includes metrology adapted and configured to determine an amount of power output of the load at each of the plurality of load control levels of the load control device to correlate the load control level to the power output level.

19. The load control system of claim 18, wherein the amount of power output of the load at each of the plurality of load control levels of the load control device is recorded in at least one of a look-up table and a transfer curve.

20. The load control system of claim 19, wherein the metrology of the load includes:
a. a microprocessor adapted and configured to determine the amount of power output of the load at each of the plurality of load control levels of the load control device; and
b. non-volatile memory to store the at least one of the look-up table and the transfer curve.

21. The load control system of claim 19, wherein the metrology of the load further includes one or more of a current transformer or a resistor divider, the metrology being adapted and configured to measure the amount of current and voltage of the load.

22. The load control system of claim 18, wherein the power output of the load for each percentage change of the load control level is determined.
